(19) United States
(12) Patent Application Publication
(10) Pub. No.: US 2025/0075667 A1
(43) Pub. Date: Mar. 6, 2025

(54) ENERGY-SAVING AND DURABLE LINKAGE MECHANISM FOR ELECTRONIC ENGINE SPEED REGULATION OF GENERATOR SETS

(71) Applicant: Yangzhou Etepor Power Technology Co., Ltd., Yangzhou, jiangsu (CN)

(72) Inventors: Jinbao CHEN, Yangzhou, Jiangsu (CN); Junjie DAI, Yangzhou, Jiangsu (CN)

(21) Appl. No.: 18/288,733

(22) PCT Filed: Jul. 15, 2022
(86) PCT No.: PCT/CN2022/105881

§ 371 Date: Oct. 27, 2023

(30) Foreign Application Priority Data
Jun. 21, 2022 (CN) 202210706123.1

(51) Int. Cl. F02D 29/06; F02D 31/00; H02K 7/075; H02K 7/18; H02K 7/20

(52) U.S. Cl. CPC F02D 29/06; F02D 31/002; H02K 7/075; H02K 7/1815; H02K 7/20

(57) ABSTRACT

An energy-saving and durable linkage mechanism for electronic engine speed regulation of generator sets, comprises an inverter, a stepping motor, a buffer linkage assembly for engine speed regulation, and a carburetor shaft. The stepping motor is electrically connected to the inverter, and the buffer linkage assembly for engine speed regulation is provided between the stepping motor's output shaft and carburetor shaft. The buffer linkage assembly for engine speed regulation comprises a crank I, crank II, link, and buffer spring. Crank I's one end is fixed to the stepping motor's output shaft, and crank II's one end is fixed to the carburetor shaft's upper end. The crank I's free end is provided with link hook hole I and spring hook hole I, and the crank II's free end is provided with link hook hole II and spring hook hole II. The invention achieves throttle opening control and buffering function with long service life.

### 1. TECHNICAL FIELD

The invention relates to the field of motor speed regulation technology, in particular to an energy-saving and durable linkage mechanism for electronic engine speed regulation of generator sets.

### 2. BACKGROUND ART

At present, the speed regulation mechanisms of engines in small and medium-sized generator sets mainly have the following forms:
(1) The output shaft of the stepping motor is directly connected to the carburetor, which is not convenient for adjusting the control of the carburetor's throttle opening.
(2) A link is provided between the output shaft of the stepping motor and the carburetor, and the rotation angle of the stepping motor is controlled by an inverter to drive the carburetor through the link to control the throttle opening. However, the above structure has rigid and direct force acting on the carburetor shaft when the link drives the carburetor and lacks a buffering function during sudden load increases and decreases, which can easily cause structural damage.
(3) A fixed spring combined with a speed regulation gear is used for generator sets. The entire generator set's speed regulation is controlled by the change in the spring's tension due to the external load size, which simultaneously drives the speed regulation gear to rotate to adjust the engine speed, output capacity, and throttle opening. Although the above structure can control the throttle opening, the entire speed regulation process is mainly adjusted by the spring separately. The spring's tension and hardness are difficult to control during the manufacturing process, causing significant differences and poor consistency. Additionally, the spring's tension and hardness will degrade after long-term use, resulting in insufficient throttle opening, limited power output, and short service life of the speed regulation mechanism.

Therefore, it is necessary to provide an energy-saving and durable linkage mechanism for electronic engine speed regulation of generator sets, satisfying the requirements of throttle opening, buffering function and long service life simultaneously.

### 3. Summary of the Invention

In response to the above background, and to improve the above existing deficiencies, the invention provides an energy-saving and durable linkage mechanism for electronic engine speed regulation of generator sets, satisfying the requirements of throttle opening, buffering function and long service life simultaneously.

The invention provides the following technical solutions: an energy-saving and durable linkage mechanism for electronic engine speed regulation of generator sets, the stepping motor is electrically connected to the inverter, and the buffer linkage assembly for engine speed regulation is provided between the output shaft of the stepping motor and the carburetor shaft; the buffer linkage assembly for engine speed regulation comprises a crank I, a crank II, a link, and a buffer spring; one end of the crank I is fixedly provided on the output shaft of the stepping motor, and one end of the crank II is fixedly provided at the upper end of the carburetor shaft; the free end of the crank I is provided with link hook hole I and spring hook hole I, with the link hook hole I provided outside the spring hook hole I, and the free end of the crank II is provided with link hook hole II and spring hook hole II, with the link hook hole II provided outside the spring hook hole II; the link hook hole I and link hook hole II are correspondingly arranged, the spring hook hole I and spring hook hole II are correspondingly provided, and the two ends of the link are hooked in link hook hole I and link hook hole II; the buffer spring is sleeved on the link, and the two ends of the buffer spring are hooked in spring hook hole I and spring hook hole II.

To further improve the hooking stability of the two ends of the link with crank I and crank II, the two ends of the link (5) are provided with L-shaped hook rod I.

Preferably, the diameters of link hook hole I and link hook hole II are larger than the diameter of the hook rod, and the diameter of the link hook hole I (7) and the link hook hole II (9) differs from the diameter of the hook rod by 3-5 mm. The existence of the diameter difference between the hook rod and each of the link hook hole I and II ensures that the hook rod can be stably hooked in link hook hole I and link hook hole II, to effectively cooperate with the buffer spring and to achieve fine adjustment of the relative distance between crank I and crank II.

To further improve the hooking stability of the two ends of the buffer spring with crank I and crank II, U-shaped hook rod II is provided at the two ends of the buffer spring.

Compared to the prior arts, the invention has the following beneficial effects: the energy-saving and durable linkage mechanism for electronic engine speed regulation of generator sets proposed by the invention achieves electronic variable-frequency speed regulation of the engine through the cooperation of crank I, crank II, and the link under the control of the inverter, thus adjusting the throttle opening according to usage requirements and achieving the technical effect of energy saving and consumption reduction. Moreover, the flexible buffering pull-adjustment is achieved through the cooperation of the buffer spring and the link, which replaces the rigid pulling of the traditional link and solves the damage to the link and crank caused by sudden load increases or decreases. The combined use of the link and buffer spring improves the durability of the buffer spring and achieves the technical effect of buffering speed regulation simultaneously.

### 4. BRIEF DESCRIPTION OF ACCOMPANY DRAWINGS

The accompanying drawings are provided to further facilitate understanding of the invention and form part of the specification and are used in conjunction with the embodiments of the invention to explain the invention, without limiting the invention. In the FIGS.:

FIG. 1 is a schematic view showing the positional structure of the energy-saving and durable linkage mechanism for electronic engine speed regulation of generator sets proposed by the invention in relation to the overall engine.

FIG. 2 is a schematic view showing the structure of the energy-saving and durable linkage mechanism for electronic engine speed regulation of generator sets proposed by the invention.

FIG. 3 is a schematic view showing the link structure of the energy-saving and durable linkage mechanism for electronic engine speed regulation of generator sets proposed by the invention.

FIG. 4 is a schematic view showing the buffer spring structure of the energy-saving and durable linkage mechanism for electronic engine speed regulation of generator sets proposed by the invention.

In the figures, 1. the stepping motor; 2. the carburetor shaft; 3. the crank I; 4. the crank II; 5. the link; 6. the buffer spring; 7. the link hook hole I; 8. the spring hook hole I; 9. the link hook hole II; 10. the spring hook hole II; 11. the hook rod I; 12. the hook rod II.

### 5. SPECIFIC EMBODIMENT OF THE INVENTION

To make the technical solutions provided by the invention more comprehensible, a further description of the invention is given below in combination with the accompanying drawings and embodiments, and the embodiments are exemplary and not the limitations of the scope of the disclosure. Apparently, the described drawings are merely some embodiments of the application rather than all the embodiments of the application. It should be understood that the application is not limited to the drawings described herein. Based on the drawings in the invention, all other drawings obtained by those of ordinary skill in the art without making creative labor fall within the scope of protection of the invention.

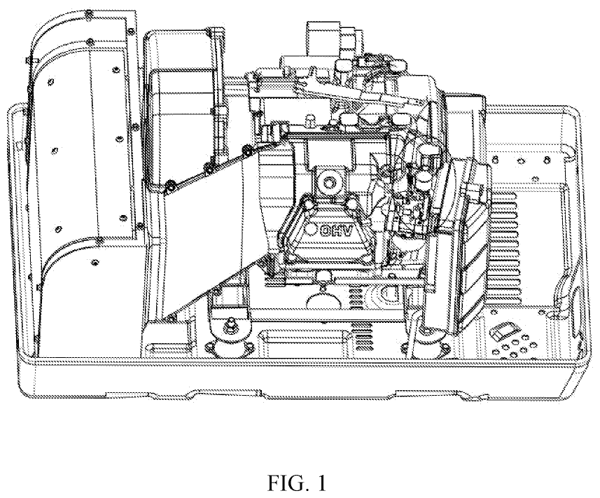

It should be noted that the terms ‘front,’ ‘back,’ ‘left,’ ‘right,’ ‘up,’ and ‘down’ used in the following description refer to the directions in the accompanying drawings, and the terms ‘inner’ and ‘outer’ refer to directions toward or away from the geometric center of specific components. As shown in FIG. 1, the technical solution provided by the invention is the part within the elliptical region in FIG. 1 (schematic view of the overall engine structure).

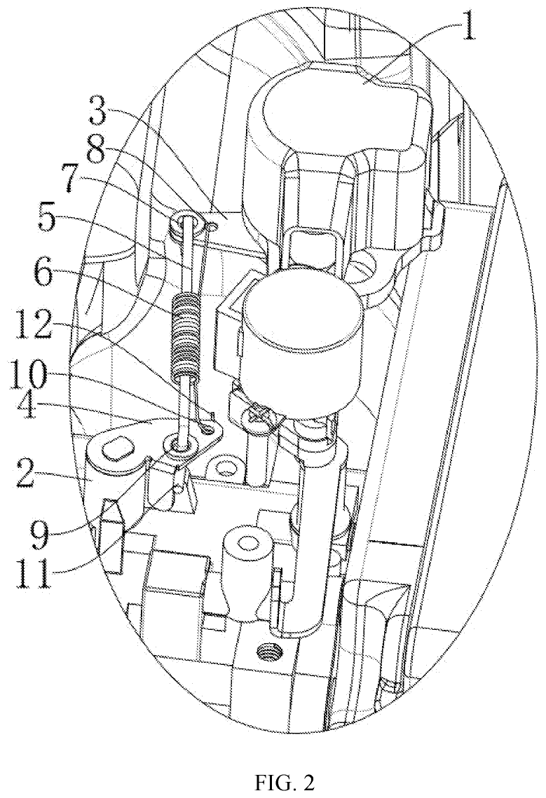

As shown in FIGS. 1 and 2, the invention has the following technical solution: an energy-saving and durable linkage mechanism for electronic engine speed regulation of generator sets, comprises the inverter, the stepping motor 1, the buffer linkage assembly for engine speed regulation, and the carburetor shaft 2. The stepping motor 1 is electrically connected to the inverter, and the buffer linkage assembly for engine speed regulation is provided between the output shaft of the stepping motor 1 and the carburetor shaft 2. The buffer linkage assembly for engine speed regulation comprises the crank I 3, the crank II 4, link 5, and buffer spring 6. One end of crank I 3 is fixedly provided on the output shaft of the stepping motor 1, and one end of crank II 4 is fixedly provided on the upper end of the carburetor shaft 2. The free end of crank I 3 is provided with link hook hole I 7 and spring hook hole I 8, with link hook hole I 7 provided outside of spring hook hole I 8. The free end of crank II 4 is provided with link hook hole II 9 and spring hook hole II 10, with link hook hole II 9 provided outside of spring hook hole II 10. Link hook hole I 7 and link hook hole II 9 are correspondingly arranged, and spring hook hole I 8 and spring hook hole II 10 are correspondingly provided. The two ends of link 5 are respectively hooked in link hook hole I 7 and link hook hole II 9. Buffer spring 6 is sleeved on link 5, and the two ends of buffer spring 6 are respectively hooked in spring hook hole I 8 and spring hook hole II 10.

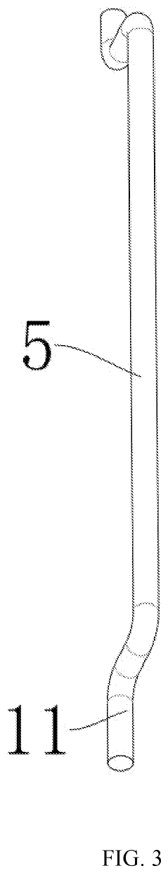

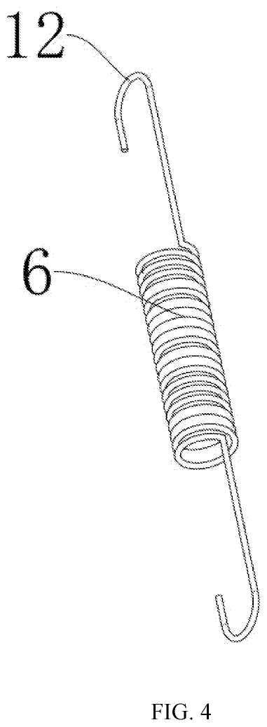

As shown in FIGS. 3 and 4, the two ends of link 5 are provided with L-shaped hook rod I 11, and the two ends of buffer spring 6 are provided with U-shaped hook rod II 12.

As shown in FIGS. 1 and 2, the diameters of link hook hole I 7 and link hook hole II 9 are larger than the diameter of the hook rod. The diameter of the link hook hole I (7) and the link hook hole II (9) differs from the diameter of the hook rod by 3-5 mm. The existence of this difference can not only ensure that the hook rod can be stably hooked within link hook hole I 7 and link hook hole II 9, to effectively cooperate with buffer spring 6 and to achieve fine adjustment of the relative distance between crank I 3 and crank II 4.

During the practical use, under the action of the inverter, the stepping motor 1 achieves a corresponding angle deflection. The output shaft of the stepping motor 1 drives crank I 3 to rotate at an angle, the crank I 3 drives crank II 4 to rotate through link 5, and the crank II 4 rotates the carburetor shaft 2. The carburetor shaft 2 controls the throttle opening, to achieve the technical effect of energy-saving and consumption reduction. In the process of crank I 3 driving crank II 4 to rotate through link 5, the buffer spring 6 enables flexible pulling between crank I 3 and crank II 4, to solve the issue of carburetor shaft damage caused by sudden load increase or decrease in traditional drive structures, which directly use rigid links to drive the carburetor shaft. The hook rod I 11 at the two ends of link 5 moves within link hook hole I 7 and link hook hole II 9, achieves a flexible speed regulation effect in combination with buffer spring 6 and ensure the durability of the speed regulation mechanism simultaneously.

In the description of the embodiments of the invention, it should be noted that relational terms such as ‘first’ and ‘second’ are used merely to distinguish one entity or action from another entity or action without necessarily requiring or implying any actual such relationship or order between them. Moreover, the terms ‘comprise,’ ‘include,’ or any other variations thereof are intended to cover a non-exclusive inclusion, such that a process, method, article, or apparatus that comprises a list of elements does not only include those elements, but also includes other elements not explicitly listed, or further includes elements inherent to such a process, method, article, or apparatus.

Although embodiments of the invention have been shown and described, it will be understood by those of ordinary skill in the art that a variety of variations, modifications, replacements and variants of these embodiments can be made without departing from the principles and spirit of the invention. Therefore, the protection scope of the invention should be subject to the protection scope defined by the claims and equivalents thereof.

1. An energy-saving and durable linkage mechanism for electronic engine speed regulation of generator sets, wherein comprises an inverter, a stepping motor (1), a buffer linkage assembly for engine speed regulation, and a carburetor shaft (2); the stepping motor (1) is electrically connected to the inverter, and the buffer linkage assembly for engine speed regulation is provided between the output shaft of the stepping motor (1) and the carburetor shaft (2); the buffer linkage assembly for engine speed regulation comprises a crank I (3), a crank II (4), a link (5), and a buffer spring (6); one end of the crank I (3) is fixedly provided on the output shaft of the stepping motor (1), and one end of the crank II (4) is fixedly provided at the upper end of the carburetor shaft (2); the free end of the crank I (3) is provided with link hook hole I (7) and spring hook hole I (8), with the link hook hole I (7) provided outside the spring hook hole I (8), and the free end of the crank II (4) is provided with link hook hole II (9) and spring hook hole II (10), with the link hook hole II (9) provided outside the spring hook hole II (10); the link hook hole I (7) and link hook hole II (9) are correspondingly arranged, the spring hook hole I (8) and spring hook hole II (10) are correspondingly provided, and the two ends of the link (5) are hooked in link hook hole I (7) and link hook hole II (9); the buffer spring (6) is sleeved on the link (5), and the two ends of the buffer spring (6) are hooked in spring hook hole I (8) and spring hook hole II (10).

2. The energy-saving and durable linkage mechanism for electronic engine speed regulation of generator sets according to claim 1, wherein the two ends of the link (5) are provided with L-shaped hook rod I (11).

3. The energy-saving and durable linkage mechanism for electronic engine speed regulation of generator sets according to claim 2, wherein the diameters of link hook hole I (7) and link hook hole II (9) are larger than the diameter of the hook rod, the diameter of the link hook hole I (7) and the link hook hole II (9) differs from the diameter of the hook rod by 3-5 mm.

4. The energy-saving and durable linkage mechanism for electronic engine speed regulation of generator sets according to claim 1, wherein the two ends of the buffer spring (6) are provided with U-shaped hook rod II (12).
